(19) United States
(12) Patent Application Publication
(10) Pub. No.: US 2023/0331622 A1
(43) Pub. Date: Oct. 19, 2023

(54) BOROSILICATE GLASS, LAMINATED GLASS, AND WINDOW GLASS FOR VEHICLE

(71) Applicant: AGC Inc., Tokyo (JP)

(72) Inventors: Rikiya KADO, Tokyo (JP); Takato KAJIHARA, Tokyo (JP); Shigeki SAWAMURA, Tokyo (JP); Shusaku AKIBA, Tokyo (JP); Yutaka KUROIWA, Tokyo (JP)

(73) Assignee: AGC Inc., Tokyo (JP)

(21) Appl. No.: 18/331,239

(22) Filed: Jun. 8, 2023

Related U.S. Application Data
(63) Continuation of application No. PCT/JP2021/046155, filed on Dec. 14, 2021.

(30) Foreign Application Priority Data
Dec. 18, 2020 (JP) 2020-210646

(51) Int. Cl. C03C 3/091; C03C 4/16; B32B 17/10; C03C 23/00

(52) U.S. Cl. CPC C03C 3/091; C03C 4/16; B32B 17/10036; C03C 23/007; B32B 17/10091; B32B 17/10119; B32B 2250/03; B32B 2250/40; B32B 2307/204; B32B 2307/7376; B32B 2605/00; B32B 2307/304; B32B 2307/412

(57) ABSTRACT

A borosilicate glass includes, in terms of molar percentage based on oxides: 70.0%≤SiO₂≤85.0%; 5.0%≤B₂O₃≤20.0%; 0.0%≤Al₂O₃≤3.0%; 0.0%≤Li₂O≤5.0%; 0.0%≤Na₂O≤5.0%; 0.0%≤K₂O≤5.0%; 0.0%≤MgO≤5.0%; 0.0%≤CaO≤5.0%; 0.0%≤SrO≤5.0%; 0.0%≤BaO≤5.0%; and 0.06%≤Fe₂O₃≤1.0%, in which the borosilicate glass has a basicity of 0.485 or more, and [AlO₃]/([SiO₂]+[B₂O₃]) of 0.015 or less.

### CROSS-REFERENCE TO RELATED APPLICATIONS

This is a bypass continuation of International Patent Application No. PCT/JP2021/046155, filed on Dec. 14, 2021, which claims priority to Japanese Patent Application No. 2020-210646, filed on Dec. 18, 2020. The contents of these applications are hereby incorporated by reference in their entireties.

### TECHNICAL FIELD

The present invention relates to a borosilicate glass, a laminated glass, and a window glass for vehicle.

### BACKGROUND ART

With development of autonomous driving, it is expected that an automobile equipped with a millimeter wave radar having a frequency of 30 GHz or more will appear and become widespread in the future.

However, in the case where such a millimeter wave radar is installed in a vehicle and a millimeter wave is transmitted through a window glass for vehicle, a window glass for vehicle in the related art has a low millimeter wave transmissibility, and is not suitable as a next generation window glass for vehicle. This is due to dielectric properties, with respect to a millimeter wave frequency band, of a soda lime glass, which is currently used in many window glasses for vehicle.

On the other hand, an alkali borosilicate glass as described in Patent Literatures 1 to 3 is known as a glass having excellent dielectric properties with respect to a millimeter wave frequency band, particularly a low dielectric loss tangent (tan δ) with respect to a millimeter wave, and is one of alternative candidates of the above soda lime glass.

Patent Literature 1: JPH04-280834A

Patent Literature 2: JPH04-285026A

Patent Literature 3: JPH07-109147A

### SUMMARY OF INVENTION

A window glass for vehicle is required to have not only a high millimeter wave transmissibility but also a high heat insulation property. When a high millimeter wave transmissibility is required not only for the window glass for vehicle, but also, for example, for a window glass for building, a high heat insulation property is also required.

However, a borosilicate glass in the related art has a problem that in the case where iron or the like is added to improve a heat insulation property, a transmittance of a light in a visible region required for an original window glass is decreased.

The present invention is to provide a borosilicate glass having a high millimeter wave transmissibility, as well as a predetermined heat insulation property and a visible light transmissibility which cannot be achieved by a borosilicate glass in the related art, and to provide a laminated glass and a window glass for vehicle including the borosilicate glass.

A borosilicate glass according to an embodiment of the present invention includes,

in terms of molar percentage based on oxides,
70.0%≤SiO₂≤85.0%;
5.0%≤B₂O₃≤20.0%;
0.0%≤Al₂O₃≤3.0%;
0.0%≤Li₂O≤5.0%;
0.0%≤Na₂O≤5.0%;
0.0%≤K₂O≤5.0%;
0.0%≤MgO≤5.0%;
0.0%≤CaO≤5.0%;
0.0%≤SrO≤5.0%;
0.0%≤BaO≤5.0%; and
0.06%≤Fe₂O₃≤1.0%, in which

the borosilicate glass has a basicity of 0.485 or more, and [AlO₃]/([SiO₂]+[B₂O₃]) of 0.015 or less.

In a borosilicate glass according to one aspect of the present invention, the basicity may be 0.488 or more.

A borosilicate glass according to one aspect of the present invention may include Li₂O: 1.5% to 5% in terms of molar percentage based on oxides.

A borosilicate glass according to one aspect of the present invention may be substantially free of Er₂O₃.

A borosilicate glass according to one aspect of the present invention may be substantially free of CeO₂ and CeO₃.

In a borosilicate glass according to one aspect of the present invention, a transmittance of a light having a wavelength of 500 nm may be 78.0% or more when a thickness of the borosilicate glass is converted into 2.00 mm.

In a borosilicate glass according to one aspect of the present invention, a transmittance of a light having a wavelength of 1000 nm may be 80.0% or less when a thickness of the borosilicate glass is converted into 2.00 mm.

In a borosilicate glass according to one aspect of the present invention, an average transmittance of a light having a wavelength of 450 nm to 700 nm may be 78.0% or more when a thickness of the borosilicate glass is converted into 2.00 mm.

In a borosilicate glass according to one aspect of the present invention, an average transmittance of a light having a wavelength of 900 nm to 1300 nm may be 80.0% or less when a thickness of the borosilicate glass is converted into 2.00 mm.

In a borosilicate glass according to one aspect of the present invention, a content of the Fe₂O₃ may be 0.10% or more in terms of molar percentage based on oxides.

In a borosilicate glass according to one aspect of the present invention, iron ions contained in the Fe₂O₃ may satisfy 0.25≤[Fe²⁺]/([Fe²⁺]+[Fe³⁺])≤0.80 on a mass basis.

In a borosilicate glass according to one aspect of the present invention, a relative dielectric constant (εᵣ) at a frequency of 10 GHz may be 6.0 or less.

In a borosilicate glass according to one aspect of the present invention, a dielectric loss tangent (tan δ) at a frequency of 10 GHz may be 0.01 or less.

A borosilicate glass according to one aspect of the present invention may be chemically strengthened or physically strengthened.

A laminated glass according to an embodiment of the present invention includes: a first glass plate; a second glass plate; and an interlayer sandwiched between the first glass plate and the second glass plate. At least one of the first glass plate and the second glass plate is the above borosilicate glass.

In a laminated glass according to one aspect of the present invention, a total thickness of the first glass plate, the second glass plate, and the interlayer may be 5.00 mm or less, and a visible light transmittance Tv defined by ISO-9050:2003 using a D65 light source may be 70% or more.

In a laminated glass according to one aspect of the present invention, a total thickness of the first glass plate, the second glass plate, and the interlayer may be 5.00 mm or less, and a total solar transmittance Tts defined by ISO-13837:2008 convention A and measured at a wind speed of 4 m/s may be 75% or less.

In a laminated glass according to one aspect of the present invention, a total thickness of the first glass plate, the second glass plate, and the interlayer may be 5.00 mm or less, and a radio wave transmission loss S21 when a radio wave having a frequency of 76 GHz to 79 GHz is incident on the first glass plate at an incident angle of 60° may be −3.0 dB or more.

In a laminated glass according to one aspect of the present invention, a total thickness of the first glass plate, the second glass plate, and the interlayer may be 5.00 mm or less, and a radio wave transmission loss S21 when a radio wave having a frequency of 76 GHz to 79 GHz is incident on the first glass plate at an incident angle of 0° to 60° may be −4.0 dB or more.

A window glass for vehicle according to an embodiment of the present invention includes the above borosilicate glass.

A window glass for vehicle according to another embodiment of the present invention includes the above laminated glass.

A borosilicate glass, a laminated glass including the borosilicate glass, and a window glass for vehicle according to the embodiments of the present invention have a high millimeter wave transmissibility, as well as a predetermined heat insulation property and a visible light transmissibility.

### BRIEF DESCRIPTION OF DRAWINGS

FIG. 1 is a cross-sectional view of an example of a laminated glass according to an embodiment of the present invention.

FIG. 2 is a conceptual view illustrating a state in which a laminated glass of an embodiment of the present invention is used as a window glass for vehicle.

FIG. 3 is an enlarged view of a portion S illustrated in FIG. 2.

FIG. 4 is a cross-sectional view taken along a line Y-Y in FIG. 3.

### DESCRIPTION OF EMBODIMENTS

Hereinafter, embodiments of the present invention will be described in detail. In the following drawings, members and portions having the same functions may be denoted by the same reference numerals, and duplicate descriptions may be omitted or simplified. The embodiments described in the drawings are schematically for the purpose of clearly explaining the present invention, and do not necessarily accurately represent a size or a scale of an actual product.

In the present description, unless otherwise specified, an evaluation such as “high/low radio wave (millimeter wave) transmissibility” means an evaluation for radio wave (including quasi-millimeter wave and millimeter wave) transmissibility, and means, for example, radio wave transmissibility of a glass with respect to a radio wave having a frequency of 10 GHz to 90 GHz.

In the present description, the expression that a glass “is substantially free of” a component means that the component is not contained except for inevitable impurities, and means that the component is not positively added. Specifically, the expression means that a content of each of these components in the glass is about 100 ppm or less in terms of molar ppm based on oxides.

### Borosilicate Glass

A borosilicate glass according to an embodiment of the present invention includes,

in terms of molar percentage based on oxides:
70.0%≤SiO₂≤85.0%;
5.0%≤B₂O₃≤20.0%;
0.0%≤Al₂O₃≤3.0%;
0.0%≤Li₂O≤5.0%;
0.0%≤Na₂O≤5.0%;
0.0%≤K₂O≤5.0%;
0.0%≤MgO≤5.0%;
0.0%≤CaO≤5.0%;
0.0%≤SrO≤5.0%;
0.0%≤BaO≤5.0%; and
0.06%≤Fe₂O₃≤1.0%.

The borosilicate glass has a basicity of 0.485 or more, and [AlO₃]/([SiO₂]+[B₂O₃]) of 0.015 or less.

The borosilicate glass is an oxide glass containing silicon dioxide as a main component and containing a boron component. The boron component in the borosilicate glass is boron oxide (generic term for boron oxides such as diboron trioxide (B₂O₃)), and a ratio of boron oxide in the glass is expressed in terms of B₂O₃.

Hereinafter, a composition range of each component contained in the borosilicate glass of the present embodiment will be described. Hereinafter, the composition range of each component is expressed in terms of molar percentage based on oxides unless otherwise specified.

SiO₂ is an essential component of the borosilicate glass of the present embodiment. A content of SiO₂ is 70.0% or more and 85.0% or less. SiO₂ contributes to an increase in Young's modulus, thereby making it easier to ensure a strength required for vehicle applications, building applications, and the like. In the case where the content of SiO₂ is small, it is difficult to ensure weather resistance, and an average linear expansion coefficient becomes too large, which may cause thermal cracking of a glass plate. On the other hand, in the case where the content of SiO₂ is too large, a viscosity at the time of melting the glass increases, which may make it difficult to produce the glass.

The content of SiO₂ in the borosilicate glass of the present embodiment is preferably 72.5% or more, more preferably 75.0% or more, still more preferably 77.5% or more, and particularly preferably 79.0% or more.

In addition, the content of SiO₂ in the borosilicate glass of the present embodiment is preferably 84.0% or less, more preferably 83.0% or less, still more preferably 82.5% or less, and particularly preferably 82.0% or less.

B₂O₃ is an essential component of the borosilicate glass of the present embodiment. A content of B₂O₃ is 5.0% or more and 20.0% or less. B₂O₃ is contained in order to increase a glass strength and radio wave (millimeter wave) transmissibility, and also contributes to improvement of a melting property.

The content of B₂O₃ in the borosilicate glass of the present embodiment is preferably 6.0% or more, more preferably 7.0% or more, still more preferably 9.0% or more, and particularly preferably 11.0% or more.

In the case where the content of B₂O₃ is too large, an alkali element is likely to volatilize during melting and forming, which may lead to a decrease in glass quality and a decrease in acid resistance and alkali resistance. Therefore, the content of B₂O₃ in the borosilicate glass of the present embodiment is preferably 18.0% or less, more preferably 17.0% or less, still more preferably 15.0% or less, and particularly preferably 14.0% or less.

Al₂O₃ is an optional component of the borosilicate glass of the present embodiment. A content of Al₂O₃ is 0.0% or more and 3.0% or less. In the case where the content of Al₂O₃ is small, it is difficult to ensure the weather resistance, and the average linear expansion coefficient becomes too large, which may cause the thermal cracking of the glass plate. On the other hand, in the case where the content of Al₂O₃ is too large, the viscosity at the time of melting the glass increases, which may make it difficult to produce the glass.

In the case where Al₂O₃ is contained, the content of Al₂O₃ is preferably 0.10% or more, more preferably 0.20% or more, and still more preferably 0.30% or more in order to prevent phase separation of the glass and improve the weather resistance.

The content of Al₂O₃ is preferably 2.5% or less, more preferably 2.0% or less, still more preferably 1.5% or less, and particularly preferably 1.0% or less from viewpoints of maintaining T₂ at a low level and making it easy to produce the glass, and from a viewpoint of increasing a radio wave (millimeter wave) transmittance.

In the present description, the T₂ represents a temperature at which a glass viscosity is 10² (dPa·s). T₄ represents a temperature at which the glass viscosity is 10⁴ (dPa·s), and T_{L} represents a liquidus temperature of the glass.

In order to increase the radio wave (millimeter wave) transmittance, SiO₂+Al₂O₃+B₂O₃ in the borosilicate glass of the present embodiment, that is, a total of the content of SiO₂, the content of Al₂O₃, and the content of B₂O₃ may be 80.0% or more and 98.0% or less.

Further, considering maintaining the temperatures T₂ and T₄ of the borosilicate glass of the present embodiment at a low level and making it easy to produce the glass, SiO₂+Al₂O₃+B₂O₃ is preferably 97.0% or less, and more preferably 96.0% or less.

However, in the case where the content of SiO₂+Al₂O₃+B₂O₃ is too small, the weather resistance may be deteriorated, and a relative dielectric constant (εᵣ) and a dielectric loss tangent (tan δ) may become too large. Therefore, SiO₂+Al₂O₃+B₂O₃ in the borosilicate glass of the present embodiment is preferably 85.0% or more, more preferably 87.0% or more, and particularly preferably 90.0% or more.

Li₂O is an optional component of the borosilicate glass of the present embodiment. A content of Li₂O is 0.0% or more and 5.0% or less. Li₂O is a component that improves the melting property of the glass, and a component that makes it easy to increase the Young's modulus and also contributes to the increase in the glass strength. By containing Li₂O, the glass viscosity is decreased, and thus formability of a window glass for vehicle, particularly a windshield or the like, is improved.

In the case where Li₂O is contained in the borosilicate glass of the present embodiment, the content thereof is preferably 0.10% or more, more preferably 1.0% or more, still more preferably 1.5% or more, particularly preferably 2.0% or more, and most preferably 2.3% or more.

On the other hand, in the case where the content of Li₂O is too large, devitrification or the phase separation may occur during the production of the glass, which may make the production difficult. In addition, a large content of Li₂O may cause an increase in raw material cost and an increase in the relative dielectric constant (εᵣ) and the dielectric loss tangent (tan δ). Therefore, the content of Li₂O is preferably 4.5% or less, more preferably 4.0% or less, still more preferably 3.5% or less, particularly preferably 3.0% or less, and most preferably 2.5% or less.

Na₂O is an optional component of the borosilicate glass of the present embodiment. A content of Na₂O is 0.0% or more and 5.0% or less.

Na₂O is a component that improves the melting property of the glass, and in the case where Na₂O is contained, Na₂O is preferably contained in an amount of 0.10% or more. Accordingly, the T₂ is easily reduced to 1900° C. or lower, and the T₄ is easily reduced to 1350° C. or lower. By containing Na₂O, the glass viscosity is decreased, and thus the formability of the window glass for vehicle, particularly the windshield, is improved.

In the case where Na₂O is contained, the content of Na₂O is preferably 0.20% or more, more preferably 0.40% or more, still more preferably 0.50% or more, particularly preferably 1.0% or more, and most preferably 2.0% or more.

On the other hand, an excessively large content of Na₂O causes the increase in the relative dielectric constant (εᵣ) and the dielectric loss tangent (tan δ), and the average linear expansion coefficient becomes too large, so that the glass plate is likely to be thermally cracked. Therefore, the content of Na₂O is preferably 4.5% or less, more preferably 4.0% or less, still more preferably 3.5% or less, even still more preferably 3.0% or less, and most preferably 2.5% or less.

K₂O is an optional component of the borosilicate glass of the present embodiment. A content of K₂O is 0.0% or more and 5.0% or less. K₂O is a component that improves the melting property of the glass, and is preferably contained in an amount of 0.10% or more. Accordingly, the T₂ is easily reduced to 1900° C. or lower, and the T₄ is easily reduced to 1350° C. or lower.

In the case where K₂O is contained, the content of K₂O is more preferably 0.30% or more, still more preferably 0.60% or more, particularly preferably 0.70% or more, and most preferably 0.80% or more.

On the other hand, an excessively large content of K₂O causes the increase in the relative dielectric constant (εᵣ) and the dielectric loss tangent (tan δ), and the average linear expansion coefficient becomes too large, so that the glass plate is likely to be thermally cracked. Therefore, the content of K₂O is preferably 4.5% or less, more preferably 4.0% or less, still more preferably 3.5% or less, even still more preferably 3.0% or less, and particularly preferably 2.5% or less.

The borosilicate glass of the present embodiment preferably contains Li₂O alone among Li₂O, Na₂O, and K₂O, from a viewpoint of the radio wave (millimeter wave) transmissibility. From viewpoints of improving the weather resistance while maintaining the melting property, Li₂O, Na₂O, and K₂O are preferably contained.

MgO is an optional component of the borosilicate glass of the present embodiment. A content of MgO is 0.0% or more and 5.0% or less. MgO is a component that promotes melting of a glass raw material and improves the weather resistance and the Young's modulus.

In the case where MgO is contained, the content of MgO is preferably 0.10% or more, more preferably 0.50% or more, and still more preferably 1.0% or more.

In addition, in the case where the content of MgO is 5.0% or less, devitrification is less likely to occur, and the increase in the relative dielectric constant (εᵣ) and the dielectric loss tangent (tan δ) can be prevented. The content of MgO is preferably 4.0% or less, more preferably 3.0% or less, still more preferably 2.5% or less, particularly preferably 2.0% or less, and most preferably 1.5% or less.

CaO is an optional component of the borosilicate glass of the present embodiment, and may be contained in a certain amount for improving the melting property of the glass raw material. A content of CaO is 0.0% or more and 5.0% or less.

In the case where CaO is contained, the content of CaO is preferably 0.10% or more, more preferably 0.50% or more, and still more preferably 1.0% or more. Accordingly, the melting property and formability (decrease in the T₂ and decrease in the T₄) of the glass raw material are improved.

In addition, by setting the content of CaO to 5.0% or less, an increase in a density of the glass is prevented, and a low brittleness and the strength are maintained. In order to prevent the glass from becoming brittle and to prevent the increase in the relative dielectric constant (εᵣ) and the dielectric loss tangent (tan δ) of the glass, the content of CaO is preferably 4.0% or less, more preferably 3.0% or less, still more preferably 2.5% or less, particularly preferably 2.0% or less, and most preferably 1.5% or less.

SrO is an optional component of the borosilicate glass of the present embodiment, and may be contained in a certain amount for improving the melting property of the glass raw material. A content of SrO is 0.0% or more and 5.0% or less.

In the case where SrO is contained, the content of SrO is preferably 0.10% or more, more preferably 0.50% or more, and still more preferably 1.0% or more. Accordingly, the melting property and formability (decrease in the T₂ and decrease in the Ta) of the glass raw material are improved.

In addition, by setting the content of SrO to 5.0% or less, the increase in the density of the glass is prevented, and the low brittleness and the strength are maintained. In order to prevent the glass from becoming brittle and to prevent the increase in the relative dielectric constant (εᵣ) and the dielectric loss tangent (tan δ) of the glass, the content of SrO is preferably 4.0% or less. In addition, the content of SrO is more preferably 3.0% or less, still more preferably 2.5% or less, and particularly preferably 2.0% or less, and it is most preferable that the borosilicate glass be substantially free of SrO.

BaO is an optional component of the borosilicate glass of the present embodiment, and may be contained in a certain amount for improving the melting property of the glass raw material. A content of BaO is 0.0% or more and 5.0% or less. In the case where BaO is contained, the content thereof is preferably 0.10% or more, more preferably 0.50% or more, and still more preferably 1.0% or more. Accordingly, the melting property and formability (decrease in the T₂ and decrease in the T₄) of the glass raw material are improved.

In addition, by setting the content of BaO to 5.0% or less, the increase in the density of the glass is prevented, and the low brittleness and the strength are maintained. In order to prevent the glass from becoming brittle and to prevent the increase in the relative dielectric constant (εᵣ) and the dielectric loss tangent (tan δ) of the glass, the content of BaO is preferably 4.0% or less. In addition, the content of BaO is more preferably 3.0% or less, still more preferably 2.5% or less, and particularly preferably 2.0% or less, and it is most preferable that the borosilicate glass be substantially free of BaO.

Fe₂O₃ is an essential component of the borosilicate glass of the present embodiment, and is contained for providing a heat insulation property. A content of Fe₂O₃ is 0.06% or more and 1.0% or less. The content of Fe₂O₃ herein refers to a total amount of iron including FeO which is an oxide of divalent iron and Fe₂O₃ which is an oxide of trivalent iron.

In the case where the content of Fe₂O₃ is less than 0.06%, the borosilicate glass may not be able to be used for applications requiring a heat insulation property, and it may be necessary to use an expensive raw material having a low iron content for production of the glass plate. Further, in the case where the content of Fe₂O₃ is less than 0.06%, heat radiation may reach a bottom surface of a melting furnace more than necessary at the time of melting the glass, and a load may be applied to the melting furnace.

The content of Fe₂O₃ in the borosilicate glass of the present embodiment is preferably 0.10% or more, more preferably 0.15% or more, still more preferably 0.17% or more, and particularly preferably 0.20% or more.

On the other hand, in the case where the content of Fe₂O₃ is more than 1.0%, heat transfer by radiation may be hindered and the raw material may be difficult to melt during the production. Further, in the case where the content of Fe₂O₃ is too large, a light transmittance in a visible region is decreased, and thus the borosilicate glass is unsuitable for a window glass for vehicle and the like. The content of Fe₂O₃ is preferably 0.80% or less, more preferably 0.50% or less, and still more preferably 0.40% or less.

In addition, iron ions contained in the above Fe₂O₃ preferably satisfy 0.25≤[Fe²⁺]/([Fe²⁺]+[Fe³⁺])≤0.80 on a mass basis. Accordingly, a transmittance of the glass plate with respect to a light in a range of 900 nm to 1300 nm is increased. In the case where the redox ([Fe²⁺]/([Fe²⁺]+[Fe³⁺])) is too low, a heat insulation property of the glass plate is deteriorated. On the other hand, in the case where the redox is too high, it may become difficult for a light of an infrared irradiation device such as a laser or a radar to pass through, or absorbability of ultraviolet rays may be decreased.

Here, the terms “[Fe²⁺]” and “[Fe³⁺]” respectively mean contents of Fe²⁺ and Fe³⁺ contained in the borosilicate glass of the present embodiment. In addition, the term “[Fe²⁺]/([Fe²⁺]+[Fe³⁺])” means a ratio of the content of Fe²⁺ to a total content of Fe²⁺ and Fe³⁺ in the borosilicate glass of the present embodiment.

[Fe²⁺]/([Fe²⁺]+[Fe³⁺]) is determined by the following method.

After decomposing a crushed glass with a mixed acid of hydrofluoric acid and hydrochloric acid at room temperature, a certain amount of a degradation solution is dispensed into a plastic container, and a hydroxylammonium chloride solution is added to reduce Fe₃⁺ in a sample solution to Fe²⁺. Thereafter, a 2,2′-dipyridyl solution and an ammonium acetate buffer solution are added to develop a color of Fe²⁺. A color development solution is adjusted to a constant amount with ion-exchanged water, and an absorbance at a wavelength of 522 nm is measured with an absorptiometer. Then, a concentration is calculated based on a calibration curve prepared by using a standard solution to determine an amount of Fe²⁺. Since Fe³⁺ in the sample solution is reduced to Fe²⁺, the amount of Fe²⁺ means “[Fe²⁺]+[Fe³⁺]” in the sample.

Next, after decomposing the crushed glass with the mixed acid of hydrofluoric acid and hydrochloric acid at room temperature, a certain amount of the degradation solution is dispensed into a plastic container, and a 2,2′-dipyridyl solution and an ammonium acetate buffer solution are quickly added to develop a color of Fe²⁺ alone. A color development solution is adjusted to a constant amount with ion-exchanged water, and an absorbance at a wavelength of 522 nm is measured with an absorptiometer. Then, a concentration is calculated based on the calibration curve prepared by using the standard solution to calculate an amount of Fe²⁺. The amount of Fe²⁺ means [Fe²⁺] in the sample.

Then, [Fe²⁺]/([Fe²⁺]+[Fe³⁺]) is calculated based on the determined [Fe²⁺] and [Fe²⁺]+[Fe³⁺].

In the borosilicate glass of the present embodiment, in the case where moisture is present in the glass, light in a near-infrared region is absorbed. Therefore, the borosilicate glass of the present embodiment preferably contains a certain amount of moisture in order to improve the heat insulation property.

The moisture in the glass can be generally expressed by a value called a β-OH value, and the β-OH value is preferably 0.050 mm⁻¹ or more, more preferably 0.10 mm⁻or more, and still more preferably 0.15 mm⁻¹ or more. β-OH is obtained by the following equation based on a transmittance of the glass measured using a Fourier transform infrared spectrophotometer (FT-IR).

β-OH=(1/X)log₁₀(T_{A}/T_{B}) [mm^{-1]}
X: sample thickness [mm]
TA: transmittance [%] at a reference wave number of 4000 cm⁻¹
TB: minimum transmittance [%] near a hydroxy group absorption wave number of 3600 cm⁻¹

On the other hand, in the case where an amount of moisture in the glass is too large, inconvenience may occur in using an infrared irradiation device (a laser, a radar, or the like) in addition to transmission and reception of a millimeter radio wave. Therefore, the β-OH value of the borosilicate glass of the present embodiment is preferably 0.70 mm⁻¹ or less, more preferably 0.60 mm⁻¹ or less, still more preferably 0.50 mm⁻¹ or less, and particularly preferably 0.40 mm⁻¹ or less.

The borosilicate glass of the present embodiment has the basicity of 0.485 or more. The borosilicate glass of the present embodiment can achieve a high visible light transmittance in the case where the basicity is 0.485 or more. Hereinafter, the basicity will be described.

The basicity of the borosilicate glass of the present embodiment indicates an electron donating property of oxygen atoms in the glass, and refers to a value (Λ_{cal}) determined by the following equation (1).

$${Λ}_{cal} = 1 - {\sum }_{i} \frac{{Z}_{i} {r}_{i}}{2} ( 1 - 1 / {γ}_{i} ) \qquad ( 1 )$$

In the equation (1), Zᵢ represents a valence of a cation i in a glass, rᵢ represents a ratio of the cation i to a total oxide ion in the glass, and γᵢ represents a basicity moderating parameter that indicates an extent to which the cation i lowers an electron donating property of oxide ions.

The symbol γᵢ has a relationship represented by the following equation (2) with a Pauling's electronegativity χ.

γᵢ=1.36(χᵢ−0.26) (2)

As described above, the borosilicate glass of the present embodiment may contain, as oxides, a glass-forming component such as SiO₂,B₂O₃, Al₂O₃, and Fe₂O3, an alkali metal oxide such as Li₂O, Na₂O, and K₂O, and an alkaline earth metal oxide such as MgO, CaO, SrO, and BaO.

SiO₂, Al₂O₃, B₂O₃, and Fe₂O₃ are components capable of decreasing the basicity.

Li₂O, MgO, CaO, and SrO are components capable of increasing the basicity.

Na₂O, K₂O, and BaO are components capable of significantly increasing the basicity.

Among these, an effect of increasing the basicity is strong in an order of K₂O>Na₂O >BaO. Therefore, the basicity of the glass can be controlled in detail by adjusting a composition ratio of K₂O, Na₂O, and BaO.

Examples of oxide ions contained in the glass include O²⁻.

Examples of the cation i in the glass include Si⁴⁺, Al³⁺, B⁴⁺, Li⁺, Na⁺, K⁺, Mg²⁺, Ca²⁺, Sr²⁺, and Ba²⁺.

The symbol rᵢ represents a ratio of the cation i to the total oxide ion in the glass, and is a value uniquely calculated based on a glass composition.

The total oxide ion in the glass is a sum of (the number of oxygen atoms in one molecule of each component×mol % of each component).

The basicity is a calculated optical basicity based on an empirical formula, and is proposed by J. A. Duffy and M. D. Ingram in J. Non-Cryst. Solids 21 (1976) 373.

The basicity of the borosilicate glass of the present embodiment is preferably 0.488 or more, and more preferably 0.490 or more.

In addition, the basicity of the borosilicate glass of the present embodiment is preferably 0.496 or less, more preferably 0.494 or less, still more preferably 0.492 or less, and particularly preferably 0.490 or less, so as not to impair a dielectric constant.

In the borosilicate glass of the present embodiment, [AlO₃]/([SiO₂]+[B₂O₃]) is 0.015 or less, preferably 0.012 or less, and more preferably 0.011 or less. Accordingly, a low dielectric constant can be maintained. Here, the terms [Al₂O₃], [SiO₂], and [B₂O₃] respectively mean the contents of Al₂O₃, SiO₂, and B₂O₃ contained in the borosilicate glass of the present embodiment.

In addition, the term “[AlO₃]/([SiO₂]+[B₂O₃])” means a ratio of the content of Al₂O₃ to a total content of SiO₂ and B₂O₃ in the borosilicate glass of the present embodiment.

In the borosilicate glass of the present embodiment, [AlO₃]/([SiO₂]+[B₂O₃]) is preferably 0.005 or more, more preferably 0.008 or more, and still more preferably 0.010 or more.

A density of the borosilicate glass of the present embodiment may be 2.0 g/cm³ or more and 2.5 g/cm³ or less.

A Young's modulus of the borosilicate glass of the present embodiment may be 50 GPa or more and 80 GPa or less.

An average linear expansion coefficient of the borosilicate glass of the present embodiment at 50° C. to 350° C. may be 25×10⁻⁷/K or more and 90×10⁻⁷/K or less.

In the case where the borosilicate glass of the present embodiment satisfies these conditions, the borosilicate glass can be suitably used as a laminated glass for vehicle or the like.

The borosilicate glass of the present embodiment preferably contains a certain amount or more of SiO₂ in order to ensure the weather resistance, and as a result, the density of the borosilicate glass of the present embodiment may be 2.0 g/cm³ or more. The density of the borosilicate glass of the present embodiment is preferably 2.1 g/cm³ or more.

In addition, in the case where the density of the borosilicate glass of the present embodiment is 2.5 g/cm³ or less, the borosilicate glass is less likely to become brittle, and weight reduction is realized. The density of the borosilicate glass of the present embodiment is preferably 2.4 g/cm³ or less.

The borosilicate glass of the present embodiment has a high rigidity as the Young's modulus increases, and is more suitable for the window glass for vehicle or the like. The Young's modulus of the borosilicate glass of the present embodiment is preferably 55 GPa or more, more preferably 60 GPa or more, and still more preferably 62 GPa or more.

On the other hand, in the case where Al₂O₃ or MgO is increased in order to increase the Young's modulus, the relative dielectric constant (εᵣ) and the dielectric loss tangent (tan δ) of the glass increase. Therefore, an appropriate Young's modulus of the borosilicate glass of the present embodiment is 75 GPa or less, preferably 70 GPa or less, and more preferably 68 GPa or less.

In the borosilicate glass of the present embodiment, by decreasing the average linear expansion coefficient, generation of thermal stress due to temperature distribution of the glass plate is prevented, and the thermal cracking of the glass plate is less likely to occur, which is preferred.

In the borosilicate glass of the present embodiment, in the case where the average linear expansion coefficient is too large, the thermal stress due to the temperature distribution of the glass plate may be likely to occur in a forming process of the glass plate, a slow cooling process, or a forming process of the windshield, and the thermal cracking of the glass plate may occur.

In addition, in the borosilicate glass of the present embodiment, in the case where the average linear expansion coefficient is too large, a difference in expansion between the glass plate and a support member or the like becomes large, which may cause distortion, and the glass plate may be broken.

Therefore, the average linear expansion coefficient of the borosilicate glass of the present embodiment at 50° C. to 350° C. may be 45×10⁻⁷/K or less, preferably 40×10⁻⁷/K or less, more preferably 38×10⁻⁷/K or less, still more preferably 36×10⁻⁷/K or less, particularly preferably 34×10⁻⁷/K or less, and most preferably 32×10⁻⁷/K or less.

On the other hand, the average linear expansion coefficient of the borosilicate glass of the present embodiment at 50° C. to 350° C. is preferably 20×10⁻⁷/K or more, more preferably 25×10⁻⁷/K or more, and still more preferably 28×10⁻⁷/K or more, from a viewpoint of performing thermal strengthening by a heat treatment.

In the borosilicate glass of the present embodiment, the T₂ is preferably 1900° C. or lower. In the borosilicate glass of the present embodiment, the T₄ is preferably 1350° C. or lower, and T₄−T_{L} is preferably −50° C. or higher.

In the case where the T₂ or the T₄ of the borosilicate glass of the present embodiment is higher than the corresponding predetermined temperature, it is difficult to produce a large glass plate with a float method, a roll-out method, a down draw method, or the like.

In the borosilicate glass of the present embodiment, the T₂ is preferably 1850° C. or lower, more preferably 1800° C. or lower, and most preferably 1750° C. or lower.

In the borosilicate glass of the present embodiment, the T₄ is more preferably 1300° C. or lower, still more preferably 1250° C. or lower, and most preferably 1200° C. or lower.

The lower limit of each of the T₂ and the T₄ of the borosilicate glass of the present embodiment is not particularly limited, and in order to maintain the weather resistance and the density of the glass, the T₂ is typically 1200° C. or higher, and the T₄ is typically 800° C. or higher.

The T₂ of the borosilicate glass of the present embodiment is preferably 1300° C. or higher, more preferably 1400° C. or higher, still more preferably 1500° C. or higher, even still more preferably 1600° C. or higher, particularly preferably 1650° C. or higher, and most preferably 1700° C. or higher.

The T₄ of the borosilicate glass of the present embodiment is preferably 900° C. or higher, and more preferably 1000° C. or higher.

Further, in order to enable production with a float method, T₄−T_{L} of the borosilicate glass of the present embodiment is preferably −50° C. or higher. In the case where this difference is less than −50° C., the devitrification occurs in the glass during glass forming, resulting in problems such as deterioration of mechanical properties of the glass and deterioration of transparency, and a high-quality glass may not be obtained.

T₄−T_{L} of the borosilicate glass of the present embodiment is more preferably 0° C. or higher, and still more preferably +20° C. or higher.

In the borosilicate glass of the present embodiment, T₁₁ is preferably 650° C. or lower, and more preferably 630° C. or lower.

In the borosilicate glass of the present embodiment, T₁₂ is preferably 620° C. or lower, and more preferably 600° C. or lower. The T₁₁ represents a temperature at which the glass viscosity is 10¹¹ (dPa·s), and the T₁₂ represents a temperature at which the glass viscosity is 10¹² (dPa·s).

In the borosilicate glass of the present embodiment, T_{g} is preferably 400° C. or higher and 650° C. or lower. In the present description, the T_{g} represents a glass transition point of the glass.

In the case where the T_{g} is within the above predetermined temperature range, the glass can be bent within a normal producing condition range. In the case where the T_{g} of the borosilicate glass of the present embodiment is lower than 400° C., there is no problem in the formability, but an alkali content or an alkaline earth content becomes too large, and problems that thermal expansion of the glass is excessive, and the weather resistance is decreased, and the like are likely to occur. In addition, in the case where the T_{g} of the borosilicate glass of the present embodiment is lower than 400° C., the glass may devitrify and may not be formed in a forming temperature range.

The T_{g} of the borosilicate glass of the present embodiment is more preferably 450° C. or higher, still more preferably 470° C. or higher, and particularly preferably 490° C. or higher.

On the other hand, in the case where the T_{g} is too high, a high temperature is required at the time of bending the glass, which makes the production difficult. The T_{g} of the borosilicate glass of the present embodiment is more preferably 600° C. or lower, and still more preferably 550° C. or lower.

In the borosilicate glass of the present embodiment, a low tan δ can be obtained by adjusting compositions, and as a result, a dielectric loss can be reduced, and a high radio wave (millimeter wave) transmittance can be achieved. In the borosilicate glass of the present embodiment, the relative dielectric constant (εᵣ) can also be adjusted by adjusting the compositions in the same manner, reflection of a radio wave at an interface with an interlayer can be prevented, and the high radio wave (millimeter wave) transmittance can be achieved.

The relative dielectric constant (εᵣ) of the borosilicate glass of the present embodiment at a frequency of 10 GHz is preferably 6.0 or less. In the case where the relative dielectric constant (εᵣ) at the frequency of 10 GHz is 6.0 or less, a difference in the relative dielectric constant (εᵣ) from the interlayer is small, and the reflection of the radio wave at the interface with the interlayer can be prevented.

The relative dielectric constant (εᵣ) of the borosilicate glass of the present embodiment at the frequency of 10 GHz is more preferably 5.5 or less, still more preferably 5.0 or less, even still more preferably 4.75 or less, particularly preferably 4.5 or less, and most preferably 4.4 or less.

The lower limit of the relative dielectric constant (εᵣ) of the borosilicate glass of the present embodiment at the frequency of 10 GHz is not particularly limited, and is, for example, 3.8 or more.

The dielectric loss tangent (tan δ) of the borosilicate glass of the present embodiment at the frequency of 10 GHz is preferably 0.01 or less. In the case where the dielectric loss tangent (tan δ) at the frequency of 10 GHz is 0.01 or less, the radio wave transmittance can be increased.

The dielectric loss tangent (tan δ) of the borosilicate glass of the present embodiment at the frequency of 10 GHz is more preferably 0.009 or less, still more preferably 0.0085 or less, even still more preferably 0.008 or less, particularly preferably 0.0075 or less, and most preferably 0.007 or less.

The lower limit of the dielectric loss tangent (tan δ) of the borosilicate glass of the present embodiment at the frequency of 10 GHz is not particularly limited, and is, for example, 0.003 or more.

In the case where the relative dielectric constant (εᵣ) and the dielectric loss tangent (tan δ) of the borosilicate glass of the present embodiment at the frequency of 10 GHz satisfy the above ranges, the high radio wave (millimeter wave) transmittance can be achieved even at a frequency of 10 GHz to 90 GHz.

The relative dielectric constant (εᵣ) and the dielectric loss tangent (tan δ) of the borosilicate glass of the present embodiment at the frequency of 10 GHz can be measured with, for example, a split post dielectric resonator method (SPDR method). For such a measurement, a nominal fundamental frequency of 10 GHz type split post dielectric resonator manufactured by QWED Company, a vector network analyzer E8361C manufactured by Keysight Technologies, 85071E option 300 dielectric constant calculation software manufactured by Keysight Technologies, or the like may be used.

A content of NiO in the borosilicate glass of the present embodiment is preferably 0.01% or less.

The borosilicate glass of the present embodiment may contain components (hereinafter, also referred to as “other components”) other than SiO₂, B₂O₃, Al₂O₃, Li₂O, Na₂O, K₂O, MgO, CaO, SrO, BaO, and Fe₂O₃, and in the case where the other components are contained, a total content thereof is preferably 5.0% or less.

Examples of the other components include, for example, ZrO₂, Y₂O₃, Nd₂O₅, P₂O₅, GaO₂, GeO₂, MnO₂, CoO, Cr₂O₃, V₂O₅, Se, Au₂O₃, Ag₂O, CuO, CdO, SO₃, Cl, F, SnO₂, and Sb₂O₃, and the other components may be metal ions or oxides.

In the borosilicate glass of the present embodiment, it is more preferable that the content of NiO be 0.010% or less and the total content of the other components be 5.0% or less, and the total content of the other components is still more preferably 3.0% or less, particularly preferably 2.0% or less, and most preferably 1.0% or less.

In the case where the borosilicate glass of the present embodiment contains NiO, formation of NiS may cause glass breakage, and thus the content of NiO is preferably 0.010% or less.

The content of NiO in the borosilicate glass of the present embodiment is more preferably 0.0050% or less, and it is still more preferable that the borosilicate glass be substantially free of NiO.

The other components may be contained in an amount of 5.0% or less for various purposes (for example, refining and coloring). In the case where the content of the other components is more than 5.0%, the radio wave (millimeter wave) transmittance may be decreased.

The content of the other components is preferably 2.0% or less, more preferably 1.0% or less, still more preferably 0.50% or less, particularly preferably 0.30% or less, and most preferably 0.10% or less. In order to prevent an influence on the environment, each of a content of As₂O₃ and a content of PbO is preferably less than 0.0010%.

The borosilicate glass of the present embodiment is preferably substantially free of Er₂O₃. Accordingly, absorption of visible light, particularly a light in a blue region to a green region (wavelength of 400 nm to 550 nm) can be prevented. In this case, an average transmittance of a light having a wavelength of 450 nm to 550 nm can be 75.0% or more when a thickness of the borosilicate glass of the present embodiment is converted into 2.00 mm.

The borosilicate glass of the present embodiment is preferably substantially free of CeO₂ and CeO₃. Accordingly, absorption of visible light, particularly a light in a blue region to a green region (wavelength of 400 nm to 550 nm) can be prevented. In this case, an average transmittance of a light having a wavelength of 450 nm to 550 nm can be 75.0% or more when a thickness of the borosilicate glass of the present embodiment is converted into 2.00 mm.

The borosilicate glass of the present embodiment may contain Cr₂O₃. Cr₂O₃ acts as an oxidant to control an amount of FeO. In the case where Cr₂O₃ is contained in the borosilicate glass of the present embodiment, a content thereof is preferably 0.0020% or more, and more preferably 0.0040% or more.

Since Cr₂O₃ has coloring in light in the visible region, a visible light transmittance may be decreased. Therefore, in the case where Cr₂O₃ is contained in the borosilicate glass of the present embodiment, the content of Cr₂O₃ is preferably 1.0% or less, more preferably 0.50% or less, still more preferably 0.30% or less, and particularly preferably 0.10% or less.

The borosilicate glass of the present embodiment may contain SnO₂. SnO₂ acts as a reducing agent to control the amount of FeO.

In the case where SnO₂ is contained in the borosilicate glass of the present embodiment, a content thereof is preferably 0.010% or more, more preferably 0.040% or more, still more preferably 0.060% or more, and particularly preferably 0.080% or more.

On the other hand, in order to prevent defects due to SnO₂ during the production of the glass plate, the content of SnO₂ in the borosilicate glass of the present embodiment is preferably 1.0% or less, more preferably 0.50% or less, still more preferably 0.30% or less, and particularly preferably 0.20% or less.

The borosilicate glass of the present embodiment may contain P₂O₅. In production of the borosilicate glass of the present embodiment with a float method, P₂O₅ improves the melting property, but tends to cause defects in the glass in a float bath. Therefore, a content of P₂O₅ in the borosilicate glass of the present embodiment is preferably 5.0% or less, more preferably 1.0% or less, still more preferably 0.50% or less, even still more preferably 0.10% or less, particularly preferably 0.050% or less, and most preferably less than 0.010%.

ZrO₂ may be contained in order to improve chemical durability, and in the case where ZrO₂ is contained, a content thereof is preferably 0.5% or more.

Since the average linear expansion coefficient may be increased, the content of ZrO₂ is more preferably 1.8% or less, and still more preferably 1.5% or less.

The borosilicate glass of the present embodiment has a sufficient visible light transmittance. The visible light transmittance of the borosilicate glass of the present embodiment is a value calculated based on a calculation equation defined in JIS R3106 (2019) using a spectrophotometer or the like.

In the borosilicate glass of the present embodiment, a transmittance of a light having a wavelength of 500 nm is preferably 78.0% or more, more preferably 80.0% or more, and still more preferably 82.0% or more when the thickness of the borosilicate glass is converted into 2.00 mm. The transmittance of the light having the above wavelength is, for example, 90.0% or less.

In the borosilicate glass of the present embodiment, an average transmittance of a light having a wavelength of 450 nm to 700 nm is preferably 78.0% or more, more preferably 80.0% or more, and still more preferably 82.0% or more when the thickness of the borosilicate glass is converted into 2.00 mm. The average transmittance of the light having the above wavelength is, for example, 90.0% or less. The average transmittance herein means an average value of transmittances measured at intervals of 1 nm.

The borosilicate glass of the present embodiment has a low near-infrared transmittance and a sufficient heat insulation property. The near-infrared transmittance of the borosilicate glass of the present embodiment is a value calculated based on the calculation equation defined in JIS R3106 (2019) using a spectrophotometer or the like.

In the borosilicate glass of the present embodiment, a transmittance of a light having a wavelength of 1000 nm is preferably 80.0% or less, more preferably 75.0% or less, and still more preferably 70.0% or less when the thickness of the borosilicate glass is converted into 2.00 mm. The transmittance of the light having the above wavelength is, for example, 50.0% or more.

In the borosilicate glass of the present embodiment, an average transmittance of a light having a wavelength of 900 nm to 1300 nm is preferably 80.0% or less, more preferably 75.0% or less, and still more preferably 70.0% or less when the thickness of the borosilicate glass is converted into 2.00 mm. The average transmittance of the light having the above wavelength is, for example, 50.0% or more. The average transmittance herein means an average value of transmittances measured at intervals of 1 nm.

A method for producing the borosilicate glass of the present embodiment is not particularly limited, and for example, a glass plate formed with a known float method is preferred. In the float method, a molten glass base material is floated on a molten metal such as tin, and a glass plate having a uniform thickness and width is formed under strict temperature control.

Alternatively, a glass plate formed with a known roll-out method or down draw method may be used, or a glass plate having a polished surface and a uniform thickness may be used.

Here, the down draw method is roughly classified into a slot down draw method and an overflow down draw method (fusion method), and both of the methods are methods in which a molten glass is continuously poured down from a formed body to form a glass ribbon in a band plate shape.

### Laminated Glass

A laminated glass according to an embodiment of the present invention includes: a first glass plate; a second glass plate; and an interlayer sandwiched between the first glass plate and the second glass plate. At least one of the first glass plate and the second glass plate is the above borosilicate glass.

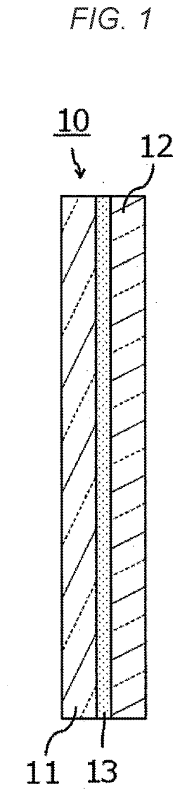

FIG. 1 is a view illustrating an example of a laminated glass 10 according to the present embodiment. The laminated glass 10 includes a first glass plate 11, a second glass plate 12 and an interlayer 13 sandwiched between the first glass plate 11 and the second glass plate 12.

The laminated glass 10 according to the present embodiment is not limited to an aspect of FIG. 1, and can be modified without departing from the gist of the present invention. For example, the interlayer 13 may be formed as one layer as illustrated in FIG. 1, or may be formed as two or more layers. The laminated glass 10 according to the present embodiment may include three or more glass plates, and in this case, an organic resin or the like may be interposed between adjacent glass plates. Hereinafter, the laminated glass 10 according to the present embodiment will be described in a configuration in which only two glass plates, that is, the first glass plate 11 and the second glass plate 12 are included, and the interlayer 13 is sandwiched therebetween.

In the laminated glass of the present embodiment, it is preferable to use the above borosilicate glass for both the first glass plate 11 and the second glass plate 12 from viewpoints of optical properties and radio wave transmissibility. In this case, the first glass plate 11 and the second glass plate 12 may be borosilicate glasses having the same composition or may be borosilicate glasses having different compositions.

In the case where one of the first glass plate 11 and the second glass plate 12 is not the above borosilicate glass, a type of the glass plate is not particularly limited, and a known glass plate in the related art used for a window glass for vehicle or the like may be used. Specific examples thereof include an alkali aluminosilicate glass and a soda lime glass. These glass plates may be colored to such an extent that transparency thereof is not impaired, or may not be colored.

In the laminated glass of the present embodiment, one of the first glass plate 11 and the second glass plate 12 may be an alkali aluminosilicate glass containing 1.0% or more of Al₂O₃. By using the above alkali aluminosilicate glass as the first glass plate 11 or the second glass plate 12, chemical strengthening can be performed as described later, and a strength can be increased. The alkali aluminosilicate glass also has an advantage of being easily chemically strengthened as compared with the borosilicate glass.

From viewpoints of weather resistance and the chemical strengthening, a content of Al₂O₃ in the above alkali aluminosilicate glass is more preferably 2.0% or more, and still more preferably 2.5% or more. In addition, in the alkali aluminosilicate glass, in the case where the content of Al₂O₃ is large, a radio wave (millimeter wave) transmittance may be decreased, and thus the content of Al₂O₃ is preferably 20% or less, and more preferably 15% or less.

From the viewpoint of the chemical strengthening, a content of R₂O in the above alkali aluminosilicate glass is preferably 10% or more, more preferably 12% or more, and still more preferably 13% or more.

In addition, in the alkali aluminosilicate glass, in the case where the content of R₂O is large, the radio wave (millimeter wave) transmittance may be decreased, and thus the content of R₂O is preferably 25% or less, more preferably 20% or less, and still more preferably 19% or less. Here, R₂O represents Li₂O, Na₂O, or K₂O.

Specific examples of the above alkali aluminosilicate glass include a glass having the following composition.
61%≤SiO₂≤77%
1.0%≤Al₂O₃≤20%
0.0%≤B₂O₃≤10%
0.0%≤MgO≤15%
0.0%≤CaO≤10%
0.0%≤SrO≤1.0%
0.0%≤BaO≤1.0%
0.0%≤Li₂O≤15%
2.0%≤Na₂O≤15%
0.0%≤K₂O≤6.0%
0.0%≤ZrO₂≤4.0%
0.0%≤TiO₂≤1.0%
0.0%≤Y₂O₃≤2.0%
10%≤R₂O≤25%
0.0%≤RO≤20%
   (R₂O represents a total amount of Li₂O, Na₂O, and K₂O, and RO represents a total amount of MgO, CaO, SrO, and BaO.)

The soda lime glass may be a soda lime glass containing less than 1.0% of Al₂O₃. Specific examples thereof include a glass having the following composition.
60%≤SiO₂≤75%
0.0%≤Al₂O₃≤1.0%
2.0%≤MgO≤11%
2.0%≤CaO≤10%
0.0%≤SrO≤3.0%
0.0%≤BaO≤3.0%
10%≤Na₂O≤18%
0.0%≤K₂O≤8.0%
0.0%≤ZrO₂≤4.0%
0.0010%≤Fe₂O₃≤5.0%

The lower limit of a thickness of the first glass plate 11 or the second glass plate 12 is preferably 0.50 mm or more, more preferably 0.80 mm or more, and still more preferably 1.50 mm or more. In the case where the thickness of the first glass plate 11 or the second glass plate 12 is 0.50 mm or more, a sound insulating property and the strength can be increased.

The first glass plate 11 and the second glass plate 12 may have the same thickness or may have different thicknesses.

In the laminated glass 10 of the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 is changed.

One or both of the first glass plate 11 and the second glass plate 12 may be subjected to a strengthening treatment in order to increase the strength. A strengthening method may be a physical strengthening or a chemical strengthening.

Examples of a method of a physical strengthening treatment include a heat strengthening treatment of a glass plate. In the heat strengthening treatment, the uniformly heated glass plate is rapidly cooled from a temperature near a softening point, and a compressive stress is generated on a surface of a glass due to a temperature difference between the surface of the glass and an inside of the glass. The compressive stress is generated uniformly over the entire surface of the glass, and a compressive stress layer having a uniform depth is formed over the entire surface of the glass. The heat strengthening treatment is more suitable for strengthening a thick glass plate than a chemical strengthening treatment.

Examples of a method of the chemical strengthening treatment include an ion exchange method. In the ion exchange method, a glass plate is immersed in a treatment liquid (for example, potassium nitrate molten salt), and ions having a small ion radius (for example, Na ions) contained in a glass are exchanged for ions having a large ion radius (for example, K ions), thereby generating a compressive stress on a surface of the glass. The compressive stress is generated uniformly over the entire surface of the glass plate, and a compressive stress layer having a uniform depth is formed over the entire surface of the glass plate.

Each of a magnitude of the compressive stress on the surface of the glass plate (hereinafter, also referred to as a surface compressive stress CS) and a depth DOL of the compressive stress layer formed on the surface of the glass plate can be adjusted by a glass composition, a chemical strengthening treatment time, and a chemical strengthening treatment temperature. Examples of a chemically strengthened glass include a glass obtained by performing the chemical strengthening treatment on the above alkali aluminosilicate glass.

The first glass plate 11 and the second glass plate 12 may have a flat plate shape, or may have a curved shape having a curvature on the entire surface or a part thereof.

In the case where the first glass plate 11 and the second glass plate 12 are curved, the first glass plate 11 and the second glass plate 12 may have a single-curved shape curved only in one of a vertical direction and a horizontal direction, or may have a multiple-curved shape curved in both the vertical direction and the horizontal direction.

In the case where the first glass plate 11 and the second glass plate 12 have the multiple-curved shape, a radius of curvature thereof may be the same or different in the vertical direction and the horizontal direction.

In the case where the first glass plate 11 and the second glass plate 12 are curved, the radius of curvature in the vertical direction and/or the horizontal direction is preferably 1000 mm or more.

A shape of a main surface of the first glass plate 11 and the second glass plate 12 is, for example, in a case of the window glass for vehicle, a shape that fits a window opening of a vehicle on which the first glass plate 11 and the second glass plate 12 are to be mounted.

The interlayer 13 according to the present embodiment is sandwiched between the first glass plate 11 and the second glass plate 12. Since the laminated glass 10 of the present embodiment includes the interlayer 13, the first glass plate 11 and the second glass plate 12 are firmly adhered to each other, and an impact force when scattered pieces collide with the glass plate can be reduced.

As the interlayer 13, various organic resins generally used for a laminated glass used as a laminated glass for a vehicle in the related art may be used. For example, polyethylene (PE), ethylene vinyl acetate copolymer (EVA), polypropylene (PP), polystyrene (PS), methacrylic resin (PMA), polyvinyl chloride (PVC), polyethylene terephthalate (PET), polybutylene terephthalate (PBT), cellulose acetate (CA), diallyl phthalate resin (DAP), urea resin (UP), melamine resin (MF), unsaturated polyester (UP), polyvinyl butyral (PVB), polyvinyl formal (PVF), polyvinyl alcohol (PVAL), vinyl acetate resin (PVAc), ionomer (IO), polymethylpentene (TPX), vinylidene chloride (PVDC), polysulfone (PSF), polyvinylidene fluoride (PVDF), methacrylate-styrene copolymer resin (MS), polyarylate (PAR), polyarylsulfone (PASF), polybutadiene (BR), polyethersulfone (PESF), polyether ether ketone (PEEK), or the like may be used. Among these, EVA and PVB are suitable from viewpoints of transparency and adhesion, and PVB is particularly preferred because PVB can provide the sound insulating property.

A thickness of the interlayer 13 is preferably 0.30 mm or more, more preferably 0.50 mm or more, and still more preferably 0.70 mm or more from viewpoints of the reduction in the impact force and the sound insulating property.

In addition, the thickness of the interlayer 13 is preferably 1.00 mm or less, more preferably 0.90 mm or less, and still more preferably 0.80 mm or less from a viewpoint of preventing a decrease in a visible light transmittance.

The thickness of the interlayer 13 is preferably in a range of 0.30 mm to 1.00 mm, and more preferably in a range of 0.70 mm to 0.80 mm.

The thickness of the interlayer 13 may be constant over the entire surface, or may be changed for each portion as necessary.

If a difference in linear expansion coefficient between the interlayer 13 and the first glass plate 11 or the second glass plate 12 is large, in the case where the laminated glass 10 is produced through a heating process to be described later, the laminated glass 10 may be cracked or warped, resulting in a poor appearance.

Accordingly, the difference in the linear expansion coefficient between the interlayer 13 and the first glass plate 11 or the second glass plate 12 is preferably as small as possible. The difference in the linear expansion coefficient between the interlayer 13 and the first glass plate 11 or the second glass plate 12 may be represented by a difference between average linear expansion coefficients in a predetermined temperature range.

Particularly, a resin constituting the interlayer 13 has a low glass transition point, and thus a predetermined average linear expansion coefficient difference may be set in a temperature range equal to or lower than the glass transition point of the resin material. A difference in linear expansion coefficient between the resin material and the first glass plate 11 or the second glass plate 12 may be set at a predetermined temperature equal to or lower than the glass transition point of the resin material.

As the interlayer 13, an adhesive layer containing an adhesive may be used, and the adhesive is not particularly limited, and for example, an acrylic adhesive or a silicone adhesive may be used.

In the case where the interlayer 13 is the adhesive layer, it is not necessary to perform the heating process in a process of bonding the first glass plate 11 and the second glass plate 12, and thus the above cracking or warpage is less likely to occur.

### Other Layers

The laminated glass 10 of the embodiment of the present invention may include layers other than the first glass plate 11, the second glass plate 12, and the interlayer 13 (hereinafter, also referred to as “other layers”) within a range that does not impair effects of the present invention. For example, a coating layer that provides a water repellent function, a hydrophilic function, an anti-fogging function, or the like, and an infrared reflective film may be provided.

Positions where the other layers are provided are not particularly limited, and the other layers may be provided on a surface of the laminated glass 10, or may be sandwiched between the first glass plate 11, the second glass plate 12, or the interlayer 13. In addition, the laminated glass 10 of the present embodiment may include a black ceramic layer or the like which is disposed in a band shape on a part or all of a peripheral edge portion for a purpose of hiding an attachment portion to a frame body or the like, a wiring conductor, or the like.

A method for producing the laminated glass 10 of the embodiment of the present invention may be the same as that for a known laminated glass in the related art. For example, through a process of laminating the first glass plate 11, the interlayer 13, and the second glass plate 12 in this order and performing heating and pressing, the laminated glass 10 having a configuration in which the first glass plate 11 and the second glass plate 12 are bonded via the interlayer 13 is obtained.

In the method for producing the laminated glass 10 according to the embodiment of the present invention, for example, after a process of heating and forming each of the first glass plate 11 and the second glass plate 12, a process of inserting the interlayer 13 between the first glass plate 11 and the second glass plate 12 and performing heating and pressing may be performed. Through such processes, the laminated glass 10 having the configuration in which the first glass plate 11 and the second glass plate 12 are bonded via the interlayer 13 may be obtained.

In the laminated glass 10 of the embodiment of the present invention, a total thickness of the first glass plate 11, the second glass plate 12, and the interlayer 13 is 5.00 mm or less, and a visible light transmittance Tv defined by ISO-9050:2003 using a D65 light source is preferably 70.0% or more, more preferably 71.0% or more, still more preferably 72.0% or more, and particularly preferably 75.0% or more. In addition, the visible light transmittance Tv is, for example, 80.0% or less. At this time, the first glass plate 11 and the second glass plate 12 may each have a thickness of 2.00 mm. Further, the total thickness of the first glass plate 11, the second glass plate 12, and the interlayer 13 may be 2.50 mm or more, 3.00 mm or more, 3.50 mm or more, 4.00 mm or more, or 4.50 mm or more.

In the laminated glass 10 according to the embodiment of the present invention, the total thickness of the first glass plate 11, the second glass plate 12, and the interlayer 13 is 5.00 mm or less, and a total solar transmittance Tts defined by ISO-13837:2008 convention A and measured at a wind speed of 4 m/s is preferably 75.0% or less. In the case where the total solar transmittance Tts of the laminated glass 10 according to the embodiment of the present invention is 75.0% or less, a sufficient heat insulation property is obtained.

The total solar transmittance Tts is more preferably 70.0% or less, still more preferably 68.0% or less, and particularly preferably 66.0% or less.

In addition, the total solar transmittance Tts is, for example, 50.0% or more.

At this time, the first glass plate 11 and the second glass plate 12 may each have a thickness of 2.00 mm. Further, the total thickness of the first glass plate 11, the second glass plate 12, and the interlayer 13 may be 2.50 mm or more, 3.00 mm or more, 3.50 mm or more, 4.00 mm or more, or 4.50 mm or more.

In the laminated glass 10 according to the embodiment of the present invention, the total thickness of the first glass plate 11, the second glass plate 12, and the interlayer 13 is 5.00 mm or less, and a radio wave transmission loss S21 when a radio wave having a frequency of 76 GHz to 79 GHz is incident on the first glass plate 11 at an incident angle of 60° is preferably −3.0 dB or more, more preferably −2.0 dB or more, and still more preferably −1.5 dB or more. In addition, the radio wave transmission loss S21 is, for example, −0.10 dB or less.

Here, the radio wave transmission loss S21 means an insertion loss derived based on a relative dielectric constant (εᵣ) and a dielectric loss tangent (tan δ) (where 8 is a loss angle) of each material used for the laminated glass, and the smaller an absolute value of the radio wave transmission loss S21 is, the higher the radio wave transmissibility is.

The incident angle means an angle of an incident direction of a radio wave from a normal line of a main surface of the laminated glass 10.

At this time, the first glass plate 11 and the second glass plate 12 may each have a thickness of 2.00 mm. Further, the total thickness of the first glass plate 11, the second glass plate 12, and the interlayer 13 may be 2.50 mm or more, 3.00 mm or more, 3.50 mm or more, 4.00 mm or more, or 4.50 mm or more.

In the laminated glass 10 according to the embodiment of the present invention, when the total thickness of the first glass plate 11, the second glass plate 12, and the interlayer 13 is 5.00 mm or less, and the radio wave transmission loss S21 when the radio wave having the frequency of 76 GHz to 79 GHz is incident on the first glass plate at an incident angle of 0° to 60° is −4.0 dB or more, angle dependency of the radio wave transmissibility is good.

The radio wave transmission loss S21 is more preferably −3.0 dB or more, and still more preferably −2.0 dB or more. In addition, the radio wave transmission loss S21 is, for example, −0.10 dB or less.

At this time, the first glass plate 11 and the second glass plate 12 may each have a thickness of 2.00 mm. Further, the total thickness of the first glass plate 11, the second glass plate 12, and the interlayer 13 may be 2.50 mm or more, 3.00 mm or more, 3.50 mm or more, 4.00 mm or more, or 4.50 mm or more.

### Window Glass for Vehicle

A window glass for vehicle of the present embodiment includes the above borosilicate glass. The window glass for vehicle of the present embodiment may be made from the above laminated glass.

Hereinafter, an example in which the laminated glass 10 of the present embodiment is used as a window glass for vehicle will be described with reference to the drawings.

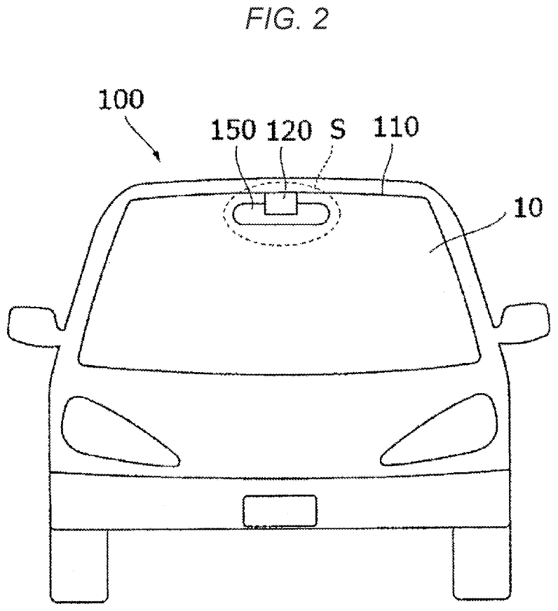

FIG. 2 is a conceptual view illustrating a state in which the laminated glass 10 of the present embodiment is mounted on an opening 110 formed at a front part of an automobile 100 and used as a window glass of the automobile. In the laminated glass 10 used as the window glass of the automobile, a housing (case) 120 in which an information device or the like is housed for ensuring traveling safety of a vehicle may be attached to a surface on an inner side of the vehicle.

The information device housed in the housing is a device that uses a camera, a radar, or the like to prevent a rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and receives a signal. The “signal” is an electromagnetic wave including a millimeter wave, a visible light, an infrared light, and the like.

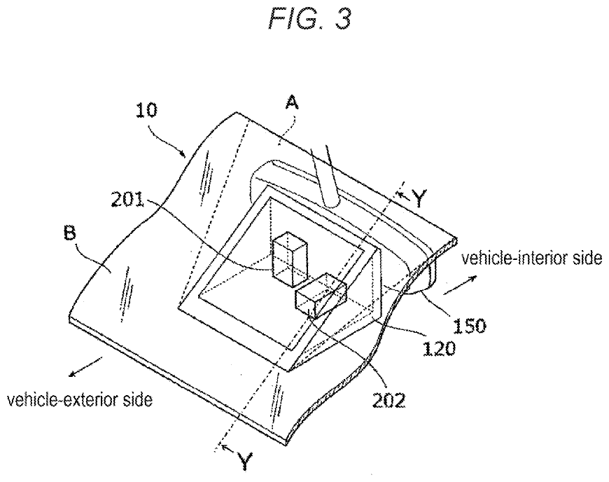

FIG. 3 is an enlarged view of a portion S illustrated in FIG. 2, and is a perspective view illustrating a portion where the housing 120 is attached to the laminated glass 10 of the present embodiment. The housing 120 stores a millimeter wave radar 201 and a stereo camera 202 as the information device. The housing 120 in which the information device is stored is normally attached to a vehicle outer side with respect to a back mirror 150 and a vehicle inner side with respect to the laminated glass 10, and may be attached to another portion.

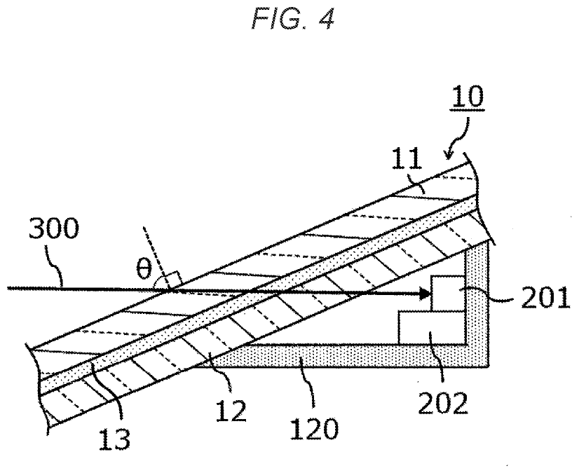

FIG. 4 is a cross-sectional view including a line Y-Y in FIG. 3 in a direction orthogonal to a horizontal line. The first glass plate 11 of the laminated glass 10 is disposed on the vehicle outer side. As described above, an incident angle θ of a radio wave 300 used for communication of the information device such as the millimeter wave radar 201 with respect to the main surface of the first glass plate 11 may be evaluated as, for example, 0° to 60° as described above.

### EXAMPLES

Hereinafter, the present invention will be specifically described with reference to Examples, but the present invention is not limited thereto.

### Production of Glass Plates of Examples 1 to 14

Raw materials were charged into a platinum crucible so as to obtain a glass composition (unit: mol %) shown in Table 1, and melted at 1650° C. for 3 hours to obtain each molten glass. Each of the molten glasses was poured onto a carbon plate and slowly cooled under a condition of 1° C./min. Both surfaces of each of the obtained plate-shaped glass were polished to obtain each glass plate having a thickness of 2.00 mm. Examples 1 to 9 are inventive examples, and Examples 10 to 14 are comparative examples.

Methods for determining numerical values shown in Table 1 are shown below.

### (1) Basicity

The basicity was determined by the following equation (1).

$${Λ}_{cal} = 1 - {\sum }_{i} \frac{{Z}_{i} {r}_{i}}{2} ( 1 - 1 / {γ}_{i} ) \qquad ( 1 )$$

In the equation (1), Zᵢ represents a valence of a cation i in a glass, rᵢ represents a ratio of the cation i to a total oxide ion in the glass, and γᵢ represents a basicity moderating parameter that indicates an extent to which the cation i lowers an electron donating property of oxide ions. The symbol γᵢ has a relationship represented by the following equation (2) with a Pauling's electronegativity χ.

γᵢ=1.36 (χᵢ−0.26) (2)

### (2) Density

About 20 g of a glass mass containing no foam and cut out from the glass plate was measured with Archimedes method.

### (3) Relative Dielectric Constant (εᵣ) and Dielectric Loss Tangent (tan δ):

The relative dielectric constant (εᵣ) and the dielectric loss tangent (tan δ) at a frequency of 10 GHz were measured with a method (SPDR method) using a split post dielectric resonator manufactured by QWED Company.

### (4) Viscosity

A temperature T₂ at which a viscosity 11 was 10² dPa·s and a temperature T₄ at which the viscosity η was 10⁴ dPa·s were measured using a rotational viscometer. In the case where the T₂ is higher than 1700° C., the T₂ is an extrapolated value based on a measurement result. A temperature T₁₁ at which the viscosity η was 1011 dPa·s and a temperature T₁₂ at which the viscosity η was 10¹² dPa·s were measured with a beam bending method.

### (5) Optical Properties

For each of the glass plates of Examples 1 to 14, transmission and reflection spectra of a light having a wavelength of 200 nm to 2500 nm were measured using a spectrophotometer LAMBDA 950 manufactured by Perkinelmer, and a transmittance of a light having a wavelength of 500 nm, a transmittance of a light having a wavelength of 1000 nm, an average transmittance of a light having a wavelength of 450 nm to 700 nm, and an average transmittance of a light having a wavelength of 900 nm to 1300 nm were determined based on ISO9050:2003.

### (6) Redox (Fe-Redox)

The [Fe²⁺]/([Fe²⁺]+[Fe³⁺]) was obtained based on the method described in the present description.

Measurement results are shown in Table 1. In Table 1, “-” indicates that no measurement was performed.

TABLE 1

| mol % | Example 1 | Example 2 | Example 3 | Example 4 | Example 5 | Example 6 | Example 7 | Example 8 |
|---|---|---|---|---|---|---|---|---|
| SiO₂ | 78.8 | 81.8 | 77.3 | 78.8 | 78.8 | 81.8 | 81.8 | 77.3 |
| B₂O₃ | 14.0 | 11.0 | 14.0 | 14.0 | 14.0 | 11.0 | 11.0 | 14.0 |
| Al₂O₃ | 1.0 | 1.0 | 1.0 | 1.0 | 1.0 | 1.0 | 1.0 | 1.0 |
| Li₂O | 2.0 | 2.0 | 2.5 | 2.0 | 2.0 | 2.0 | 2.0 | 2.5 |
| Na₂O | 2.0 | 2.0 | 2.5 | 2.0 | 2.0 | 2.0 | 2.0 | 2.5 |
| K₂O | 2.0 | 2.0 | 2.5 | 2.0 | 2.0 | 2.0 | 2.0 | 2.5 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 0 | 0 | 0 | 0 | 0 | 0 | 0 | 0 |
| Fe₂O₃ | 0.19 | 0.19 | 0.19 | 0.19 | 0.19 | 0.19 | 0.19 | 0.19 |
| [Fe²⁺]/([Fe²⁺] + | 0.25 | 0.28 | 0.27 | 0.38 | 0.55 | 0.38 | 0.55 | 0.38 |
| [Fe³⁺]) | | | | | | | | |
| [Al₂O₃]/([SiO₂] + | 0.0108 | 0.0108 | 0.0109 | 0.0108 | 0.0108 | 0.0108 | 0.0108 | 0.0109 |
| [B₂O₃]) | | | | | | | | |
| Basicity | 0.488 | 0.490 | 0.493 | 0.488 | 0.488 | 0.490 | 0.490 | 0.493 |
| Density (g/cm³) | 2.23 | 2.26 | 2.27 | 2.23 | 2.23 | 2.26 | 2.26 | 2.27 |
| εᵣ@10 GHz | 4.61 | 4.68 | 4.85 | 4.61 | 4.61 | 4.68 | 4.68 | 4.85 |
| tan δ | 0.0056 | 0.0061 | 0.0061 | 0.0056 | 0.0056 | 0.0061 | 0.0061 | 0.0061 |
| T₁₁ (° C.) | 640 | 645 | 627 | 640 | 640 | 645 | 645 | 627 |
| T₁₂ (° C.) | 611 | 618 | 597 | 611 | 611 | 618 | 618 | 597 |
| T₄ (° C.) | 1145 | 1197 | 1102 | 1145 | 1145 | 1197 | 1197 | 1102 |
| T₂ (° C.) | 1709 | 1781 | 1634 | 1709 | 1709 | 1781 | 1781 | 1634 |
| Transmittance | 81.4 | 83.4 | 84.9 | 80.0 | 79.0 | 81.6 | 82.4 | 83.6 |
| @500 nm, 2 mt (%) | | | | | | | | |
| Transmittance | 79.1 | 73.5 | 74.4 | 73.0 | 63.7 | 65.4 | 55.5 | 66.3 |
| @1000 nm, 2 mt (%) | | | | | | | | |
| Average transmittance@ | 81.8 | 83.3 | 84.8 | 81.0 | 79.5 | 81.4 | 81.3 | 83.3 |
| 450 nm to 700 nm (%) | | | | | | | | |
| Average transmittance@ | 79.6 | 73.9 | 74.7 | 73.4 | 64.1 | 66.2 | 56.3 | 67.0 |
| 900 nm to 1300 nm (%) | | | | | | | | |

| mol % | Example 9 | Example 10 | Example 11 | Example 12 | Example 13 | Example 14 |
|---|---|---|---|---|---|---|
| SiO₂ | 77.3 | 69.5 | 83.3 | 83.3 | 80.3 | 66.0 |
| B₂O₃ | 14.0 | 0 | 11.6 | 11.6 | 14.0 | 7.5 |
| Al₂O₃ | 1.0 | 0.9 | 1.1 | 1.1 | 1.0 | 11.0 |
| Li₂O | 2.5 | 0 | 0 | 0 | 1.5 | 0 |
| Na₂O | 2.5 | 12.6 | 3.3 | 3.3 | 1.5 | 0 |
| K₂O | 2.5 | 0.6 | 0.5 | 0.5 | 1.5 | 0 |
| MgO | 0 | 7.1 | 0 | 0 | 0 | 5.7 |
| CaO | 0 | 9.1 | 0 | 0 | 0 | 4.9 |
| SrO | 0 | 0 | 0 | 0 | 0 | 4.9 |
| BaO | 0 | 0 | 0 | 0 | 0 | 0.04 |
| Fe₂O₃ | 0.19 | 0.18 | 0.19 | 0.05 | 0.19 | 0.02 |
| [Fe²⁺]/([Fe²⁺] + | 0.55 | 0.20 | 0.22 | 0.32 | 0.26 | — |
| [Fe³⁺]) | | | | | | |
| [Al₂O₃]/([SiO₂] + | 0.0109 | 0.0129 | 0.0116 | 0.0116 | 0.0106 | 0.1496 |
| [B₂O₃]) | | | | | | |
| Basicity | 0.493 | 0.572 | 0.483 | 0.483 | 0.483 | 0.524 |
| Density (g/cm³) | 2.27 | 2.50 | 2.20 | 2.20 | 2.20 | 2.50 |
| εᵣ@10 GHz | 4.85 | 6.71 | 4.46 | 4.46 | 4.33 | 5.38 |
| tan δ | 0.0061 | 0.0122 | 0.0080 | 0.0080 | 0.0048 | 0.0049 |
| T₁₁ (° C.) | 627 | 613 | 630 | 630 | 649 | <800 |
| T₁₂ (° C.) | 597 | 590 | 590 | 590 | 617 | 769 |
| T₄ (° C.) | 1102 | 1041 | 1270 | 1270 | >1200 | 1275 |
| T₂ (° C.) | 1634 | 1464 | 1850 | 1850 | >1800 | 1645 |
| Transmittance | 82.7 | 87.3 | 73.5 | 93.7 | 75.9 | 82.1 |
| @500 nm, 2 mt (%) | | | | | | |
| Transmittance | 60.2 | 59.4 | 80.0 | 93.2 | 81.0 | 56.7 |
| @1000 nm, 2 mt (%) | | | | | | |
| Average transmittance@ | 82.0 | 83.9 | 75.6 | 92.7 | 76.9 | 81.8 |
| 450 nm to 700 nm (%) | | | | | | |
| Average transmittance@ | 60.9 | 60.5 | 80.3 | 92.7 | 81.2 | 57.1 |
| 900 nm to 1300 nm (%) | | | | | | |

In each of the glasses of Examples 1 to 9, a transmittance of a light having a wavelength of 500 nm and an average transmittance of a light having a wavelength of 450 nm to 700 nm when a thickness was 2.00 mm were 78.0% or more, so that a good visible light transmittance was obtained.

In addition, it was found that in each of the glasses of Examples 1 to 9, a transmittance of a light having a wavelength of 1000 nm and an average transmittance of a light having a wavelength of 900 nm to 1300 nm when the thickness was 2.00 mm were 80.0% or less, and a near-infrared transmittance was low, and thus a good heat insulation property was obtained.

In each of the glasses of Examples 1 to 9, a relative dielectric constant (εᵣ) at a frequency of 10 GHz was 6.0 or less, and a dielectric loss tangent (tan δ) at a frequency of 10 GHz was 0.01 or less, so that a good radio wave transmissibility was exhibited.

As described above, it was found that each of the glasses of Examples 1 to 9 had a high millimeter wave transmissibility, satisfied a predetermined heat insulation property, and had a certain visible light transmittance.

On the other hand, in the glass of Example 10, a relative dielectric constant (εᵣ) at a frequency of 10 GHz was more than 6.0, and a dielectric loss tangent (tan δ) at a frequency of 10 GHz was more than 0.01, so that radio wave transmissibility was poor.

In the glass of Example 11, a transmittance of a light having a wavelength of 500 nm and an average transmittance of a light having a wavelength of 450 nm to 700 nm when a thickness was 2.00 mm were less than 78.0%, so that a visible light transmittance was poor.

In the glass of Example 12, a transmittance of a light having a wavelength of 1000 nm and an average transmittance of a light having a wavelength of 900 nm to 1300 nm when a thickness was 2.00 mm were more than 80.0%, and a near-infrared transmittance was high, and thus a heat insulation property was poor.

In the glass of Example 13, a transmittance of a light having a wavelength of 500 nm and an average transmittance of a light having a wavelength of 450 nm to 700 nm when a thickness was 2.00 mm were less than 78.0%, so that a visible light transmittance was poor. In the glass of Example 13, a transmittance of a light having a wavelength of 1000 nm and an average transmittance of a light having a wavelength of 900 nm to 1300 nm when the thickness was 2.00 mm were more than 80.0%, and a near-infrared transmittance was high, and thus a heat insulation property was poor.

### Production of Laminated Glass

Laminated glasses of Production Examples 1 to 20 were produced by the following procedure. Production Examples 1 to 12 and Production Examples 18 to 20 are inventive examples, and Production Examples 13 to 17 are comparative examples. In each of Production Examples 18 to 20, a thickness of a first glass plate is different from a thickness of a second glass plate.

### Production Example 1

A borosilicate glass (Example 1) having a thickness of 2.00 mm and a composition shown in Table 1 was used as each of a first glass plate and a second glass plate. Polyvinyl butyral having a thickness of 0.76 mm was used as an interlayer. The first glass plate, the interlayer, and the second glass plate were laminated in this order, and subjected to a pressure bonding treatment (1 MPa, 130° C., 3 hours) using an autoclave to produce a laminated glass of Production Example 1. In the laminated glass of Production Example 1, a total thickness of the first glass plate, the second glass plate, and the interlayer was 4.76 mm.

### Production Examples 2 to 20

The laminated glasses of Production Examples 2 to 20 were produced in the same manner as in Production Example 1 except for items shown in Tables 2 to 4.

### Optical Properties

For each of the laminated glasses of Production Examples 1 to 20, transmission and reflection spectra of a light having a wavelength of 200 nm to 2500 nm were measured using a spectrophotometer LAMBDA 950 manufactured by Perkinelmer.

A visible light transmittance (Tv) was measured with a method defined by ISO-9050:2003 using a D65 light source.

A total solar transmittance (Tts) was measured with a method defined by ISO-13837:2008 convention A and measured at a wind speed of 4 m/s.

Results are shown in Tables 2, 3, and 4.

### Radio Wave Transmissibility

For each of the laminated glasses of Production Examples 1 to 20, a radio wave transmission loss S21 of a radio wave having a frequency of 76 GHz to 79 GHz that was incident at an incident angle of 0° to 60° was calculated based on a relative dielectric constant εᵣ and a dielectric loss tangent tan 8 of each material used. Specifically, antennas were opposed to each other, and each of the obtained laminated glasses was placed between the antennas so that an incident angle was 0° to 60°. Then, for TM waves having a frequency of 76 GHz to 79 GHz, the radio wave transmission loss S21 was measured when a value of a case where there was no radio wave transmissive substrate at an opening of 100 mm Φ was set to 0 [dB], and radio wave transmissibility was evaluated according to the following criteria.

### Evaluation of Radio Wave Transmissibility

[Incident angle: 60°]

○: −3.0 dB≤S21

x: S21<−3.0 dB

[Incident angle: 0° to 60°]

○: −4.0 dB≤S21

x: S21<−4.0 dB

Results are shown in Tables 2, 3, and 4.

TABLE 2

| | | Production | Production | Production | Production | Production | Production | Production | Production | Production |
|---|---|---|---|---|---|---|---|---|---|---|
| | | Example 1 | Example 2 | Example 3 | Example 4 | Example 5 | Example 6 | Example 7 | Example 8 | Example 9 |
| First glass | Glass | Example 1 | Example 2 | Example 3 | Example 5 | Example 6 | Example 7 | Example 8 | Example 9 | Example 10 |
| plate | Thickness | 2.00 mm | 2.00 mm | 2.00 mm | 2.00 mm | 2.00 mm | 2.00 mm | 2.00 mm | 2.00 mm | 2.00 mm |
| Interlayer | Material | PVB | PVB | PVB | PVB | PVB | PVB | PVB | PVB | PVB |
| | Thickness | 0.76 mm | 0.76 mm | 0.76 mm | 0.76 mm | 0.76 mm | 0.76 mm | 0.76 mm | 0.76 mm | 0.76 mm |
| Second | Glass | Example 1 | Example 2 | Example 3 | Example 5 | Example 6 | Example 7 | Example 8 | Example 9 | Example 1 |
| glass plate | Thickness | 2.00 mm | 2.00 mm | 2.00 mm | 2.00 mm | 2.00 mm | 2.00 mm | 2.00 mm | 2.00 mm | 2.00 mm |
| Optical | Tv | 73.5 | 74.7 | 77.4 | 70.2 | 71.6 | 72.2 | 75.2 | 73.2 | 76.2 |
| properties | Tts | 74.1 | 71.8 | 73.2 | 67.0 | 67.4 | 63.7 | 69.0 | 65.9 | 69.8 |
| Radio | S21@60° ≥ −3.0 dB | ∘ | ∘ | ∘ | ∘ | ∘ | ∘ | ∘ | ∘ | ∘ |
| wave | S21@0° to | ∘ | ∘ | ∘ | ∘ | ∘ | ∘ | ∘ | ∘ | x |
| transmis- | 60° ≥ −4.0 dB | | | | | | | | | |
| sibility | | | | | | | | | | |

TABLE 3

| | | Production | Production | Production | Production | Production | Production | Production | Production |
|---|---|---|---|---|---|---|---|---|---|
| | | Example 10 | Example 11 | Example 12 | Example 13 | Example 14 | Example 15 | Example 16 | Example 17 |
| First glass | Glass | Example 10 | Example 10 | Example 14 | Example 10 | Example 11 | Example 12 | Example 13 | Example 10 |
| plate | Thickness | 2.00 mm | 2.00 mm | 0.70 mm | 2.00 mm | 2.00 mm | 2.00 mm | 2.00 mm | 2.00 mm |
| Interlayer | Material | PVB | PVB | PVB | PVB | PVB | PVB | PVB | PVB |
| | Thickness | 0.76 mm | 0.76 mm | 0.76 mm | 0.76 mm | 0.76 mm | 0.76 mm | 0.76 mm | 0.76 mm |
| Second | Glass | Example 2 | Example 3 | Example 7 | Example 10 | Example 11 | Example 12 | Example 13 | Example 11 |
| glass plate | Thickness | 2.00 mm | 2.00 mm | 3.20 mm | 2.00 mm | 2.00 mm | 2.00 mm | 2.00 mm | 2.00 mm |
| Optical | Tv | 77.3 | 78.7 | 76.3 | 79.0 | 59.4 | 92.4 | 62.2 | 68.9 |
| properties | Tts | 68.9 | 69.6 | 67.0 | 66.0 | 68.8 | 87.4 | 71.0 | 67.5 |
| Radio | S21@60° ≥ −3.0 dB | ∘ | ∘ | ∘ | x | ∘ | ∘ | ∘ | ∘ |
| wave | S21@0° to | x | x | ∘ | x | ∘ | ∘ | ∘ | x |
| transmis- | 60° ≥ −4.0 dB | | | | | | | | |
| sibility | | | | | | | | | |

TABLE 4

| | | Production | Production | Production |
|---|---|---|---|---|
| | | Example 18 | Example 19 | Example 20 |
| First glass plate | Glass | Example 7 | Example 9 | Example 9 |
| | Thickness | 3.50 mm | 3.20 mm | 3.20 mm |
| Interlayer | Material | PVB | PVB | PVB |
| | Thickness | 0.76 mm | 0.76 mm | 0.76 mm |
| Second glass plate | Glass | Example 7 | Example 9 | Example 9 |
| | Thickness | 0.70 mm | 0.70 mm | 1.00 mm |
| Optical properties | Tv | 72.6 | 73.6 | 72.3 |
| | Tts | 64.7 | 67.7 | 66.5 |
| Radio wave | S21@60° ≥ −3.0 dB | ∘ | ∘ | ∘ |
| transmissibility | S21@0° to 60° ≥ −4.0 dB | ∘ | ∘ | ∘ |

In each of the laminated glasses of Production Examples 1 to 12 and Production Examples 18 to 20, a visible light transmittance Tv was as high as 70% or more, and a good visible light transmittance was exhibited. In each of the laminated glasses of Production Examples 1 to 12 and Production Examples 18 to 20, a total solar transmittance Tts was 75% or less, and a good heat insulation property was exhibited.

In each of the laminated glasses of Production Examples 1 to 12 and Production Examples 18 to 20, a radio wave transmission loss S21 of a radio wave having a frequency of 76 GHz to 79 GHz that was incident at an incident angle of 60° was −3.0 dB or more, and radio wave transmissibility was excellent. Among these, in each of the laminated glasses of Production Examples 1 to 8 and Production Examples 18 to 20, the borosilicate glass of the present invention was used for both the first glass plate and the second glass plate, and thus a radio wave transmission loss S21 of a radio wave having a frequency of 76 GHz to 79 GHz that was incident at an incident angle of 0° to 60° was −4.0 dB or more, and angle dependency of the radio wave transmissibility was particularly excellent.

As described above, it was found that each of the laminated glasses of Production Examples 1 to 12 and Production Examples 18 to 20 had high millimeter wave transmissibility, a predetermined heat insulation property, and a visible light transmissibility.

On the other hand, in the laminated glass of Production Example 13, a radio wave transmission loss S21 of a radio wave having a frequency of 76 GHz to 79 GHz that was incident at an incident angle of 60° was less than −3.0 dB, and a radio wave transmission loss S21 of a radio wave having a frequency of 76 GHz to 79 GHz that was incident at an incident angle of 0° to 60° was less than −4.0 dB, so that radio wave transmissibility was poor.

In the laminated glass of Production Example 14, a visible light transmittance Tv was as low as less than 70%, and a visible light transmittance was poor.

In the laminated glass of Production Example 15, a total solar transmittance Tts was more than 75%, and a heat insulation property was poor.

In the laminated glass of Production Example 16, a visible light transmittance Tv was as low as less than 70%, and a visible light transmittance was poor.

In the laminated glass of Production Example 17, a visible light transmittance Tv was as low as less than 70%, and a visible light transmittance was poor.

Although various embodiments have been described above with reference to the drawings, it is needless to say that the present invention is not limited to such examples. It is apparent to those skilled in the art that various changes and modifications can be conceived within the scope of the claims, and it is also understood that such changes and modifications belong to the technical scope of the present invention. Constituent elements in the embodiments described above may be combined freely within a range not departing from the spirit of the invention.

The present application is based on Japanese Patent Application No. 2020-210646 filed on Dec. 18, 2020, the contents of which are incorporated herein by reference.

### REFERENCE SIGNS LIST

10: laminated glass
11: first glass plate
12 : second glass plate
13 interlayer
100: automobile
110: opening
120: housing
150: back mirror
201: millimeter wave radar
202: stereo camera
300: radio wave

What is claimed is:

1. A borosilicate glass comprising,
in terms of molar percentage based on oxides:
70.0%≤SiO₂≤85.0%;
5.0%≤B₂O₃≤20.0%;
0.0%≤Al₂O₃≤3.0%;
0.0%≤Li₂O≤5.0%;
0.0%≤Na₂O≤5.0%;
0.0%≤K₂O≤5.0%;
0.0%≤MgO≤5.0%;
0.0%≤CaO≤5.0%;
0.0%≤SrO≤5.0%;
0.0%≤BaO≤5.0%; and
0.06%≤Fe₂O₃≤1.0%, wherein
the borosilicate glass has a basicity of 0.485 or more, and [AlO₃]/([SiO₂]+[B₂O₃]) of 0.015 or less.

2. The borosilicate glass according to claim 1, wherein the basicity is 0.488 or more.

3. The borosilicate glass according to claim 1, comprising,
in terms of molar percentage based on oxides:
Li₂O: 1.5% to 5%. 25 4. The borosilicate glass according to claim 1, being substantially free of Er₂O₃.

5. The borosilicate glass according to claim 1, being substantially free of CeO₂ and CeO₃.

6. The borosilicate glass according to claim 1, having a transmittance of a light having a wavelength of 500 nm of 78.0% or more when a thickness of the borosilicate glass is converted into 2.00 mm.

7. The borosilicate glass according to claim 1, having a transmittance of a light having a wavelength of 1000 nm of 80.0% or less when a thickness of the borosilicate glass is converted into 2.00 mm.

8. The borosilicate glass according to claim 1, having an average transmittance of a light having a wavelength of 450 nm to 700 nm of 78.0% or more when a thickness of the borosilicate glass is converted into 2.00 mm.

9. The borosilicate glass according to claim 1, having an average transmittance of a light having a wavelength of 900 nm to 1300 nm of 80.0% or less when a thickness of the borosilicate glass is converted into 2.00 mm.

10. The borosilicate glass according to claim 1, having a content of the Fe₂O₃ of 0.10% or more in terms of molar percentage based on oxides.

11. The borosilicate glass according to claim 10, wherein iron ions contained in the Fe₂O₃ satisfy 0.25≤[Fe²⁺]/([Fe²⁺]+[Fe³⁺])≤0.80 on a mass basis.

12. The borosilicate glass according to claim 1, having a relative dielectric constant (εᵣ) at a frequency of 10 GHz of 6.0 or less.

13. The borosilicate glass according to claim 1, having a dielectric loss tangent (tan δ) at a frequency of 10 GHz of 0.01 or less.

14. The borosilicate glass according to claim 1, being chemically strengthened or physically strengthened.

15. A laminated glass comprising:
a first glass plate;
a second glass plate; and
an interlayer sandwiched between the first glass plate and the second glass plate, wherein
at least one of the first glass plate and the second glass plate is the borosilicate glass according to claim 1.

16. The laminated glass according to claim 15, wherein the first glass plate, the second glass plate, and the interlayer have a total thickness of 5.00 mm or less, and
the laminated glass has a visible light transmittance Tv defined by ISO-9050:2003 using a D65 light source of 70% or more.

17. The laminated glass according to claim 15, wherein the first glass plate, the second glass plate, and the interlayer have a total thickness of 5.00 mm or less, and
the laminated glass has a total solar transmittance Tts defined by ISO-13837:2008 convention A and measured at a wind speed of 4 m/s of 75% or less.

18. The laminated glass according to claim 15, wherein the first glass plate, the second glass plate, and the interlayer have a total thickness of 5.00 mm or less, and
the laminated glass has a radio wave transmission loss S21 when a radio wave having a frequency of 76 GHz to 79 GHz is incident on the first glass plate at an incident angle of 60° of −3.0 dB or more.

19. The laminated glass according to claim 15, wherein the first glass plate, the second glass plate, and the interlayer have a total thickness of 5.00 mm or less, and
the laminated glass has a radio wave transmission loss S21 when a radio wave having a frequency of 76 GHz to 79 GHz is incident on the first glass plate at an incident angle of 0° to 60° of −4.0 dB or more.

20. A window glass for vehicle, comprising the borosilicate glass according to claim 1.

21. A window glass for vehicle, comprising the laminated glass according to claim 15.
